(19) United States
(12) Patent Application Publication
(10) Pub. No.: US 2010/0077961 A1
(43) Pub. Date: Apr. 1, 2010

(54) Pet Furniture

(76) Inventors: John M. Lipscomb, Cedarburg, WI (US); Stanley L. Suring, Cedarburg, WI (US)

Correspondence Address: BOYLE FREDRICKSON S.C., 840 North Plankinton Avenue, MILWAUKEE, WI, 53203, US

(21) Appl. No.: 12/571,362

(22) Filed: Sep. 30, 2009

Related U.S. Application Data
(60) Provisional application No. 61/101,436, filed on Sep. 30, 2008.

(51) Int. Cl. A01K 29/00; A01K 15/02

(52) U.S. Cl. 119/28.5; 119/702

(57) ABSTRACT

Pet furniture embodiments including one unit that is a bunk when in one orientation and which can be disposed in another orientation forming a nestable enclosure and another unit that includes a maze that can be of multi-level or multi-tiered construction. Assemblies and methods are disclosed for tool-less assembly including one unit utilizing a first tool-less latching arrangement for assembling walls and a second tool-less latching arrangement for assembling a platform upon which a pet can perch, rest or lay to walls when assembled and another unit with hingedly connected walls that include a pair of opposed walls formed by wall sections also hingedly joined enabling the walls to be unfolded from a compact stack during assembly to form a platform-supporting frame that can include one or more integrally formed passages that permit a pet to explore underneath the platform.

### CROSS REFERENCE

This application claims priority under 35 U.S.C. §119(e) to U.S. Provisional Patent Application No. 61/101,436, filed Sep. 30, 2008, the entirety of which is hereby expressly incorporated by reference herein.

### FIELD

The present invention relates to an interactive unit for a pet and more particular to pet furniture capable of providing pet interaction while being of easy to assemble construction.

### BACKGROUND

Domestic animals, particularly cats, like to perch on raised platforms as well as nest in boxes and enclosures. However, many of the current pet beds, cat houses and other types of pet furniture are heavy, hard to ship, or else made of flimsy material. In many instances, the units are sold to the consumer as fully assembled, which increases shipping costs. Where unassembled, the pet furniture may be assembled at home by the consumer, but may require tools and detailed directions that can be complicated for the average pet owner.

Thus, there is a need to provide improved pet furniture.

### SUMMARY

The present invention is directed to pet furniture that can take the form of an assembly capable of being assembled without using any tools and which can be of modular construction for ease of construction. In one preferred embodiment, the pet furniture assembly includes a bed and can be oriented in a manner that provides a bunk where the bed is on top and is reversible to provide a nestable box where the bed can be disposed on the bottom. In another preferred embodiment, the pet furniture is configured to provide a multi-tiered maze that is particular well suited for domestic house cats.

In one embodiment, the pet furniture assembly is formed of a plurality of pairs of opposed walls that carry a platform that can be configured to provide a support surface for a pet, such as to enable the pet to perch, rest or sleep thereon. Each pair of adjacent walls is engageable during assembly in a manner that requires no tools. The platform is a panel that also is engaged to one or more of the walls in a manner that requires no tools. Releasable engagement enables disassembly if it is desired to stow the pet furniture away.

In one embodiment, there are a plurality of sidewalls that releasably engage each one of a plurality of end walls via a latching arrangement that can include a coupling extension that is disposed interiorly along a corner formed where each one of the sidewalls and end wall engage. Such a latching arrangement can include a latch receiver that can releasably receive an outwardly extending engagement arrangement that includes a post or the like that releasably yet securely engages the latch receiver during assembly. In one preferred embodiment, the latch receiver includes a bracket or plate constructed and arranged to engage and secure the engagement arrangement. In a preferred implementation, the latch receiver is a keyhole fitting that receives a post with an enlarged head.

The platform is a panel that includes a plurality of movable couplers that engage a plurality of the walls. For example, in one preferred embodiment, each coupler includes a movable finger that is extended outwardly to engage part of a corresponding one of the walls. In one embodiment, the finger is received in a recess formed in a corresponding one of the sidewalls while the platform is disposed on one or more locators carried by the sidewalls. In another embodiment, the panel is received in a slot in each sidewall that is located relative to a corresponding recess or pocket formed in the sidewall in which one of the coupling fingers is received. In one preferred embodiment, each coupler is a turn button whose rotatable finger is receivable in a channel formed in each sidewall that can be a rabbet.

In another preferred pet furniture embodiment, a first pair of opposed walls are joined via hinges to a second pair of opposed walls with one of the pairs of opposed walls being hinged to enable the entire assembly to be folded up into a compact stack. A platform that can be formed of a plurality of panels connected via another hinge cooperates with a latching arrangement to be releasably attachable when the first and second pairs of walls are unfolded into a platform support frame. The latching arrangement includes a plurality of clips that each releasably receive a dowel with the clips carried by one of the platform and frame and the dowels carried by the other one of the platform and frame. For example, in a preferred embodiment, each one of the platform panels carries a plurality of dowel underneath its top surface and one of the pairs of opposed walls has a plurality of inwardly extending dowels that underlie the platform during assembly so as to register with and be engaged by a corresponding one of the clips in attaching the platform to the frame. The platform can receive a pad, such as of a mattress, upon which a pet can perch, rest or lay.

In a still further preferred pet furniture embodiment, an enclosure is defined that includes a plurality of animal sized openings that permit pet entry within along with at least one divider that defines a plurality of maze passages or chambers that a pet inside the enclosure can explore. In one embodiment, the divider is horizontally disposed defining a plurality of vertically separated maze passages or chamber levels. In a preferred embodiment, the divider has at least one animal sized opening permitting a pet inside the maze to travel between maze passages or chambers.

Various other features, advantages and objects will be made apparent from the following detailed description and the drawings.

### DRAWING DESCRIPTION

Preferred exemplary embodiments of the invention are illustrated in the accompanying drawings, in which like reference numerals represent like parts throughout, and in which:

FIG. 1 is a side perspective view of a first embodiment of pet furniture;

FIG. 2 is a top perspective view of the first pet furniture embodiment.

FIG. 3 is a perspective view of one sidewall of the pet furniture embodiment shown in FIGS. 1 and 2;

FIG. 4 is a perspective view of another sidewall of the pet furniture embodiment shown in FIGS. 1 and 2;

FIG. 5 is a perspective view of one end wall of the pet furniture embodiment shown in FIGS. 1 and 2;

FIG. 6 is a perspective view of another end wall of the pet furniture embodiment shown in FIGS. 1 and 2;

FIG. 7 is a perspective view of a top or bottom panel of the pet furniture embodiment shown in FIGS. 1 and 2;

FIG. 8 is a perspective view of the first pet furniture embodiment shown fully assembled and in a first orientation;

FIG. 9 is a perspective view of another implementation of the first pet furniture embodiment shown assembled and in a second orientation;

FIG. 10 is an exploded view of a roof overlying the first pet furniture embodiment;

FIG. 11 is a perspective view of the roof assembled to the first pet furniture embodiment;

FIG. 12 is a perspective view of a second embodiment of pet furniture in a completely disassembled condition;

FIG. 13 is a perspective view of second pet furniture embodiment in a partially assembled condition;

FIG. 14 is a perspective view of second pet furniture embodiment in an assembled condition;

FIG. 15 is a perspective view of a third embodiment of pet furniture that is a multi-tiered cat maze; and

FIG. 16 is a second perspective view of the third pet furniture embodiment.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

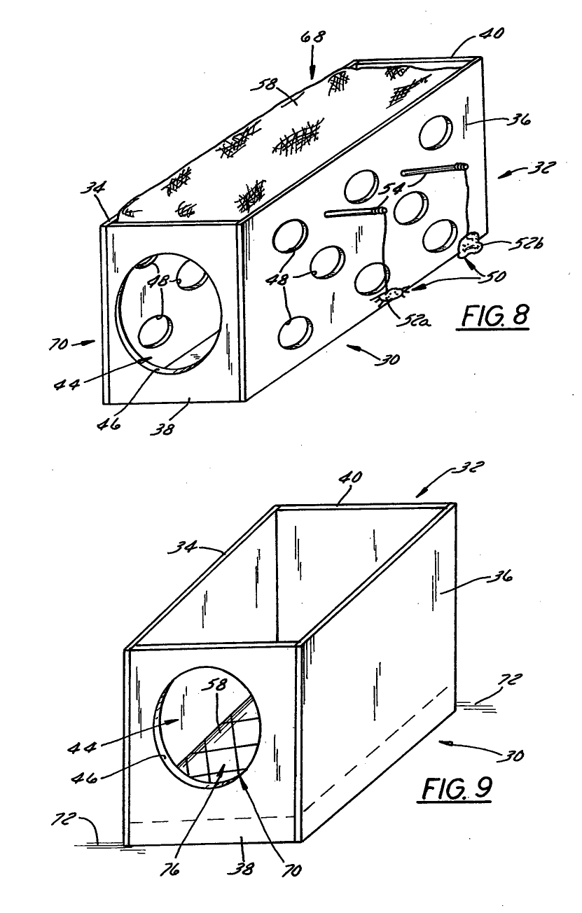

FIGS. 1-9 illustrates a first embodiment of a pet furniture assembly 30 that can be configured for animal interaction and which also is configurable to provide housing, an enclosure that can be protective and/or a pet support, such as a bed. The pet furniture assembly 30 is of modular construction and capable of being assembled manually without using any tools. The pet furniture assembly 30 is particularly well-suited for use with domestic pets kept in a house, such as a cat or the like.

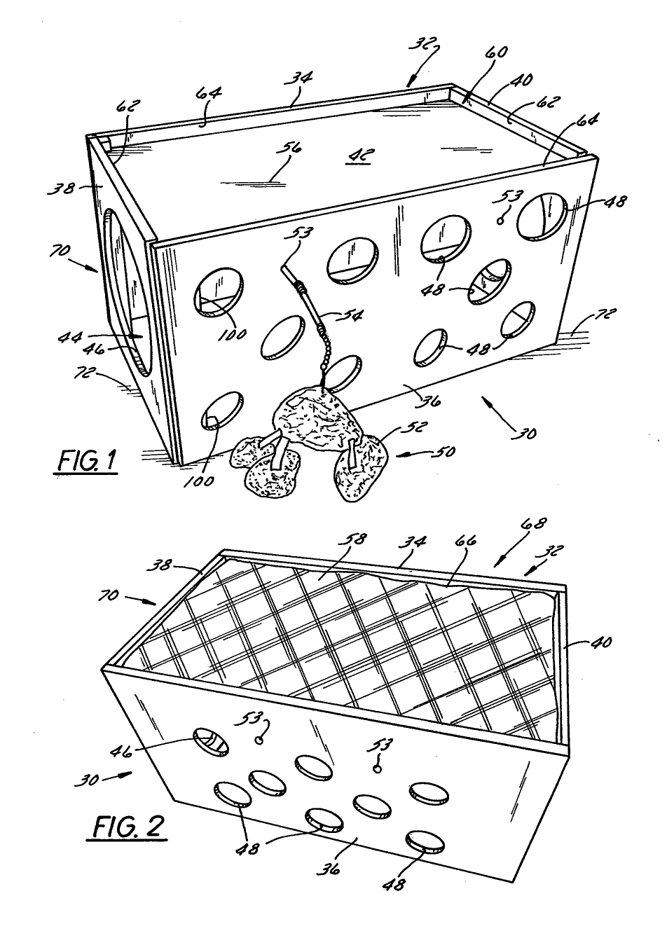

With specific reference to FIGS. 1 and 2, the pet furniture assembly 30 is a box 32 that can be of elongate construction as shown having a pair of opposed and spaced apart sidewalls 34, 36 attached to a pair of spaced apart and opposed end walls 38, 40 with a panel 42 extending therebetween. One of the walls, such as end wall 38, is configured with a passage 44 large enough to allow passage of a pet (not shown) therethrough permitting pet ingress and/or egress. As is best shown in FIGS. 2 and 7, the passage 44 is a circular opening 46 formed in end wall 38.

Each one of the sidewalls 34, 36 is a generally rectangular board or panel made of a suitably strong and durable material, such as wood. Similarly, each one of the end walls 38, 40 is of generally square or rectangular construction and also made of a suitably strong and durable material, such as wood. Finally, panel 42 is generally rectangular and also made of a suitably strong and durable material, such as wood. In one preferred embodiment, each one of the walls 34-40 and panel 42 are made of a pressed fiberboard, such as medium density fiberboard (MDF). If desired, one or more or all of these can be made of another type of material, such as plastic or the like.

As previously indicated, the pet furniture assembly 30 can be configured in a manner that entices or encourages pet interaction. For example, one or more of the walls can include one or more openings 48 of a size that at least permits a pet located inside or outside of the box 30 to see therethrough. In the preferred embodiment shown in FIGS. 1-9, each one of the smaller sized openings 48 are sized large enough to allow a pet to insert a limb or portion thereof through the opening 48. For example, where the pet is a domestic cat, openings 48 preferably are sized large enough to allow a cat to insert its paw therethrough. In addition, as is best shown in FIGS. 1, 2 and 4, each wall, e.g., sidewall 36, equipped with such openings 48 has at least a plurality of adjacent openings 48 spaced close enough together to permit a paw of a cat to be inserted through one opening 48 while the cat looks through an adjacent opening 48. In one embodiment, there is at least plurality of pairs, i.e., at least three, such openings 48 formed in at least one of the walls. For example, as is shown in FIGS. 1, 2 and 4, sidewall 36 has ten such openings 48 formed therein disposed in two groups of five openings 48 with each openings group having a pair of spaced apart openings 48 disposed adjacent an upper and lower portion of the sidewall 36 with a single opening 48 centrally disposed between the upper and lower pairs. This enables cats of various sizes to be able to extend a paw through one of the openings 48 while being able to look through an opening 48 located above it.

To further encourage or entice pet interaction, one of the walls, such as sidewall 36, can be configured to accept a plaything 50, such as a cat toy 52 carried by an elongate wand 54 that extends outwardly from the wall 36. Other types of playthings that include other types of cat toys, such as feathers, balls, etc., can be used. To accommodate attachment of a plaything 50 to the wall 36, the wall 36 has a plurality of plaything holders or anchors 53 that can be receptacles formed in the wall 36. For example, each plaything holder 53 can include a threaded nut (not shown) embedded in the wall 36 that threadably receives a threaded stem of the wand 54 in attaching the plaything 50 to the wall.

With continued reference to FIGS. 1 and 2, panel 42 is generally horizontally disposed and has an outer surface 56 upon which a pad 58, such as a layer of fabric that can be of padded construction, can be disposed. The fabric layer 58 is shown in FIG. 2 as overlying the outer surface 56 of panel 42. With reference to FIG. 1, the pad 58 is disposed in a recess 60 formed by panel 42 and an edge 62, 64 of the walls 34-40 that extends upwardly above the outer surface 56 of panel 42. The upraised edges of walls 34-40 border an outside edge 66 of the pad 58, such as in the manner shown in FIG. 2. When the pet furniture assembly 30 is configured as shown in FIG. 2 with a pad 58 disposed on panel 42, it provides a support surface that is enticing to a pet, such as a cat, to rest upon. Indeed, when configured as shown in FIG. 2, this arrangement can provide a bed 68 upon which a cat can rest or even sleep.

When the pet furniture assembly 30 is oriented as shown in FIGS. 1, 2 and 8, box 32 forms a substantially enclosed enclosure 70 having three sides defined by walls 34, 36 and 40, a top defined by platform 42, and a bottom formed by a support surface 72, such as the ground or a floor, with passage 44 permitting a pet, e.g., cat, to enter or exit the enclosure 70. The furniture assembly 30 is convertible by flipping it over 180° as shown in FIG. 9 such that the box 32 has an open top 74 with the platform 42 being disposed adjacent to and overlying support surface 72. When disposed in the orientation shown in FIG. 9, the surface 57 (FIG. 7) of the panel 42 opposite surface 56 forms a floor upon which pad 58 can be placed defining an enclosed bed 76 in which a pet, such as a cat, can rest or even sleep. When oriented forming substantially enclosed enclosure 70, one set of outer edges of the walls 34-40 rests on the support surface 72 and when flipped over oriented as an open top box, an opposite said of outer edges of the walls 34-40 rests on the support surface 72.

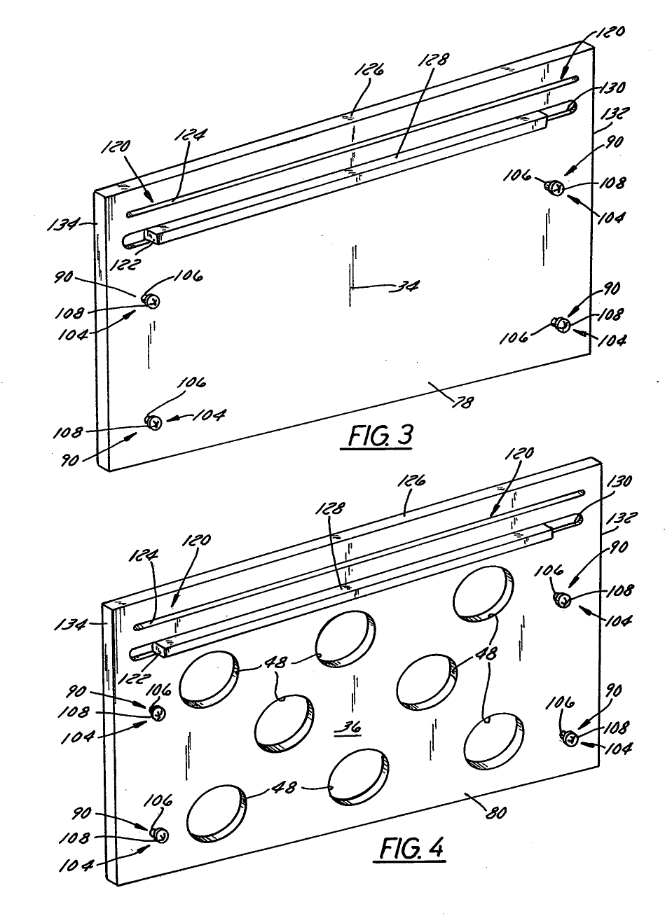

With reference to FIGS. 3-7, the pet furniture assembly 30 can be formed modularly of separate components, including the sidewalls 34, 36, the end walls 38, 40 and the platform 42 that doubles as an enclosure ceiling when an assembled pet furniture assembly 30 is disposed in one position, such as the position shown in FIGS. 1, 2 and 8, and as a floor when the assembled pet furniture assembly 30 is disposed in an opposite position, such as the position shown in FIG. 9. In a currently preferred embodiment, these separate components can be manually assembled without using any tools as discussed in more detail below.

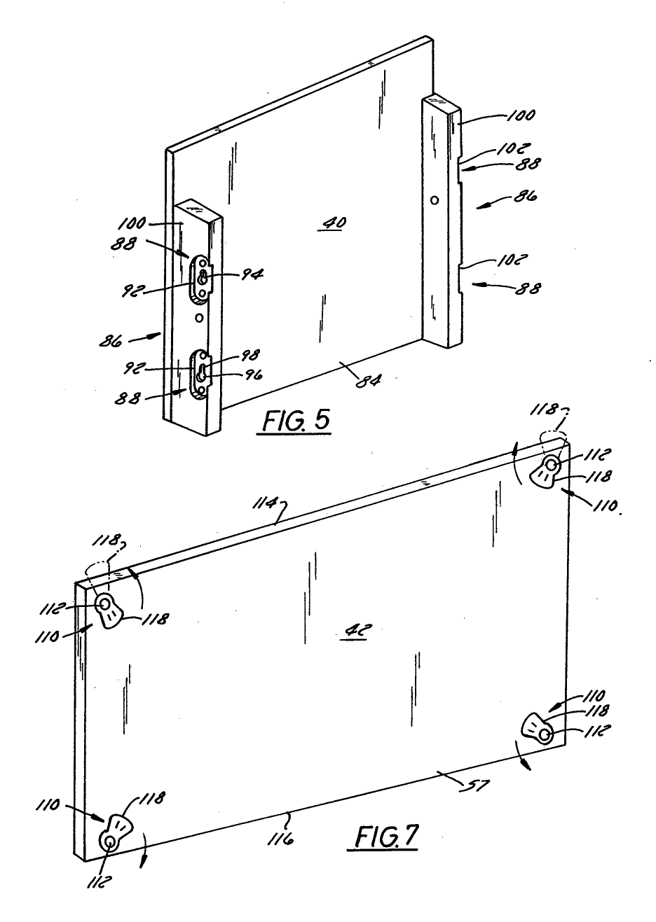

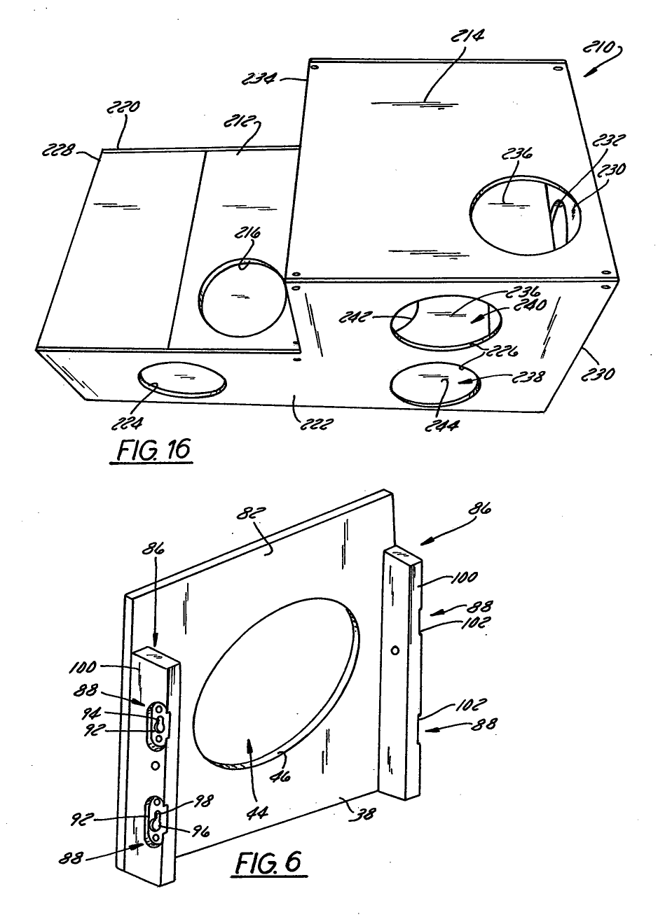

FIGS. 3 and 4, illustrate preferred but exemplary embodiments of respective sidewalls 34, 36 and FIGS. 5 and 6 illustrate preferred but exemplary embodiments of respective end walls 38, 40. Each sidewall 34, 36 has a respective interiorly disposed surface 78, 80 configured so as to enable engagement with a portion of each one of the end walls 38, 40 in a manner that securely and positively assembles them together. Likewise, each end wall 38, 40 has a respective interiorly disposed surface 82, 84 configured in a manner that enables engagement with a portion of each one of the sidewalls 34, 36.

In a preferred embodiment, a latching arrangement carried by one or both of sidewalls 34, 36 and end walls 38, 40 enables tool-less coupling therebetween during assembly of the pet furniture assembly 30. The latching arrangement is constructed and arranged to facilitate attachment, including in a releasable manner, at or along the corners or corner edges where each sidewall 34, 36 and each end wall 38, 40 converge in forming respective corners of box 32. As discussed in more detail below, each latching arrangement can include a coupling extension carried by one plurality of walls, such as end walls 38, 40 used to facilitate engagement during assembly with a respective engagement portion of another plurality of walls, such as sidewalls 34, 36.

As is shown in FIGS. 5 and 6, each end wall 38, 40 carries a coupling extension 86 that carries at least one latch receiver 88 that releasably engages a respective engagement portion 90 that can extend outwardly from a corresponding one of the sidewalls 34, 36 when assembling the walls together. In the preferred embodiment shown in FIGS. 5 and 6, there is a plurality of spaced apart latch receivers 88. In a preferred embodiment, each latch receiver 88 can be a bracket or plate, such as a keyhole fitting 92 having a keyhole slot 94 with an enlarged slot portion 96 at one end and a narrower slot portion 98 extending therefrom. Each keyhole fitting 92 is fixed to coupling extension 86, such as by fasteners or the like.

Each coupling extension 86 is a flange 100 extending outwardly from a respective interior surface 82, 84 of a corresponding end wall 38, 40 adjacent an outer side edge, such as depicted in FIGS. 5 and 6. In the preferred embodiment shown in FIGS. 5 and 6, each flange 100 is formed by an elongate board that can be fixed to a corresponding end wall 38, 40, such as by using an adhesive, fasteners or the like. To help facilitate assembly, each keyhole fitting 92 can be recessed or otherwise disposed in a pocket 102 formed in the flange 100 to which it is attached.

As is shown in FIGS. 3 and 4, each sidewall 34, 36 has a plurality of engagement portions 90 that are each releasably and slidably received in a slot 94 of a corresponding keyhole fitting 92 during assembly. Each engagement portion 90 can be in the form of a post 104 that extends outwardly from a corresponding interior surface 78, 80 of a respective sidewall 34, 36. In a currently preferred embodiment, each post 104 has an outwardly extending shank 106 with an enlarged head 108 disposed at its free end. During assembly, one of the sidewalls, e.g. sidewall 34 or 36, is manually maneuvered relative to one of the end walls, e.g., end wall 38 or 40, until the head 108 of each one of the engagement posts 104 along one side edge of the sidewall is received in the enlarged slot portion 96 of a corresponding keyhole slot 94 of respective fitting 92. Relative manual movement between the sidewall and end wall causes each post 104 to slide along the slot 94 in which is received until its head 108 is received in the narrower portion 98 of the slot 94 thereby preventing disengagement.

Referring now to FIGS. 3, 4 and 7, panel 42 and a plurality of walls, e.g., sidewalls 34, 40, are assembled toollessly using a latching arrangement that employs a plurality of movable or displaceable couplers 110 that includes a finger 118 movable between a disengaged position, such as shown in FIG. 7, during assembly to an engaged position where it extends outwardly from the panel 42 in assembling the panel 42 to at least a plurality of walls. As is shown in FIG. 7, the panel 42 has at least a plurality of pairs, i.e., at least three, couplers 110 attached by a pivot 112 that can be a fastener or the like. Each one of the couplers 110 is disposed adjacent a respective side edge 114, 116 of the panel 42 that is going to be disposed toward a corresponding one of the walls to which the panel 42 is being assembled. In one preferred exemplary embodiment, each one of the couplers 110 is a turn button.

With specific reference to FIGS. 3 and 4, each one of the walls, e.g., sidewalls 34, 36, to which the panel 42 is attached during assembly includes a socket that is a recess 120 in which an outwardly extending portion of a corresponding one of the fingers 118 of coupler 110 is received when the finger 118 is manually moved from a disengaged position, such as that shown in FIG. 7, to an engaged position where it extends outwardly beyond an adjacent side edge 114 or 116 during assembly. In a preferred embodiment, each recess 120 is an elongate rabbet or channel 124 formed in a corresponding surface 78, 80 of respective sidewall 34, 36 that extends adjacent and along one of its edges 126.

To help facilitate panel assembly, each sidewall 34, 36 can include a platform locator 122 upon which the panel 42 can be placed prior to moving each coupler finger 118 toward an engaged position where is received in a corresponding one of the recesses 120. Each platform locator 122 extends outwardly and can be elongate so as to help locate and support the platform 42 during assembly along substantially the entire length of the platform 42. In addition, after assembly, the platform locator 122 can help support the platform 42, such as when a pet is resting or sleeping thereon. Each locator 122 is an elongate strut 128 fixed to a corresponding sidewall 34, 36 such as by using an adhesive, fasteners or the like. In one embodiment, as is depicted in FIGS. 3 and 4, each strut 128 is received in an elongate channel 130 that extends generally parallel to rabbet 124 but disposed outwardly of the rabbet 124 and edge 126. Each strut 128 can be adhesively attached to corresponding sidewall 34, 36.

In another preferred embodiment, channel 130 of each sidewall 34, 36 can be of a width about the same or greater than the cross sectional width of the platform 42 and extend all the way to one or both sidewall edges 132, 134 so as to enable panel 42 to be received in each channel 130 during assembly. Each recess 120 is spaced above channel 130 so as to receive a respective coupler finger 118 during assembly to securely yet releasably assemble panel 42 to sidewalls 34, 36.

In assembly, a plurality of pairs of walls, such as sidewalls 34, 36 and one of the end walls 38 or 40, are assembled together such as in the manner described above resulting in the walls forming a U-shape. Thereafter, platform 42 is assembled, such as in the manner described above, before the last wall, such as the other one of the end walls 38 or 40, is assembled. Finally, where a pad 58 is used, it is placed on one of the surfaces 56 or 57 of the platform 42, depending upon which way the assembled assembly 30 is oriented.

In a preferred method of assembly, sidewalls 34 and 36 are each attached to one of the end walls 38 or 40, by attaching one of the sidewalls, such as sidewall 34, to the endwall and then attaching the other one of the sidewalls, such as sidewall 36, to the endwall. After that, platform 42 is assembled by placing it on locator supports 122 and then rotating each coupling finger 118 to its outwardly extended position so it received in a corresponding recess 120, such as channel 124, in a respective one of the sidewalls 34, 36. Where locator supports 122 are lacking, platform 42 can be slid in slot 130 of each sidewall 34, 36 from the end opposite the assembled end wall until the platform 42 is disposed adjacent or in abutment with the assembled end wall. Thereafter, the other end wall is attached to sidewalls 34, 36 producing a pet furniture assembly 30 in accordance with that depicted in FIG. 1. Of course, if desired pad 58 can be placed on platform 42. If desired, the pet furniture assembly 30 can be flipped over and used as an open box type cat bed such as is depicted in FIG. 9.

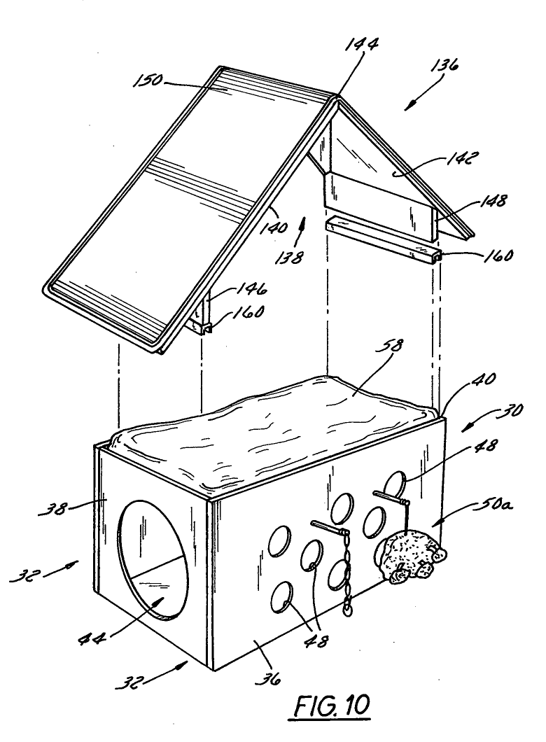

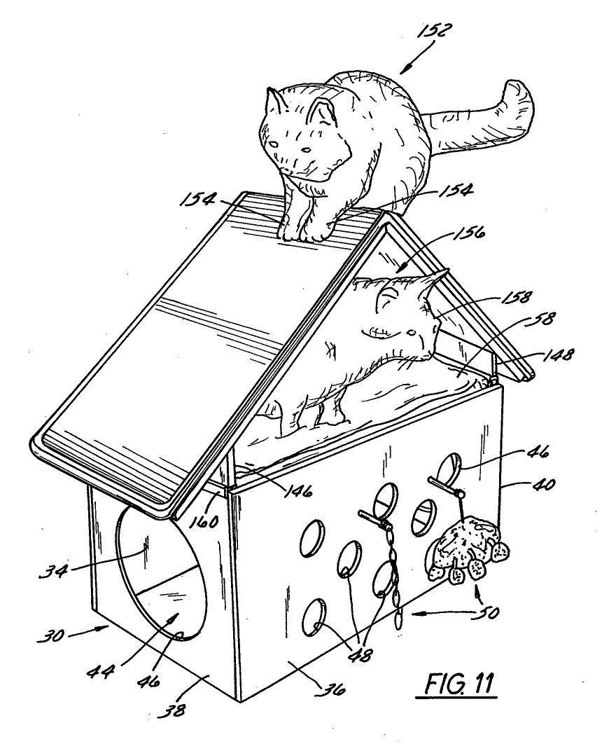

FIGS. 10 and 11 illustrate a preferred embodiment of a roof assembly 136 that can be of Gable roof construction formed of a panel arrangement 138 that can be formed of a first panel 140 attached or otherwise coupled to a second panel 142 at an angle relative thereto defining a hip 144 that is a top edge or apex of the roof 136. The roof 136 is constructed and arranged to be mountable on an object, such as pet furniture assembly 30 shown in FIGS. 10 and 11. For example, roof 136 can be constructed with a pair of outwardly extending legs 146, 148 that engage a portion of pet furniture assembly 30 such that the roof 136 overlies a portion and preferably substantially all of the pet furniture assembly 30.

In the embodiment shown in FIGS. 10 and 11, the roof 136 is constructed and arranged to releasably engage pet furniture assembly 30 in a manner where it positively insecurely remains in place during use and operation. For example, as is shown in FIG. 10, each leg 146, 148 extends downwardly from a respective roof panel 140, 142 and is configured in a manner where it is engageable with a corresponding outer edge of one of the walls of the pet furniture assembly 30. In the embodiment shown in FIGS. 10 and 11, each leg 146, 148 carries a channel 160 that receives a corresponding outer edge of one of the walls of the pet furniture assembly 30. Channel 160 has a generally U-shaped cross-section and can slidably and frictionally engage each wall alongside the outer edge of the wall. In the preferred embodiment shown in FIGS. 10 and 11, each leg 146, 148 has a channel 160 fixed thereto that receives an outer edge of a corresponding one of the end walls 38, 40.

The top or outer surface of the roof 136 can be covered with fabric or material 150, such as sisal, on which a cat 152 can scratch its paws 154, such as in the manner depicted in FIG. 11 when disposed on top of the roof. The roof overlies panel 42 and pad 58 of pet furniture assembly 30 and is spaced apart therefrom providing sufficient space 156 underneath so as to enable a cat 158 to perch, rest, or lay underneath such as is shown in FIG. 11. In addition, such a roof assembly 136 can advantageously be used with the pet furniture assembly 30 whether oriented as shown in FIG. 11 or oriented as shown in FIG. 9.

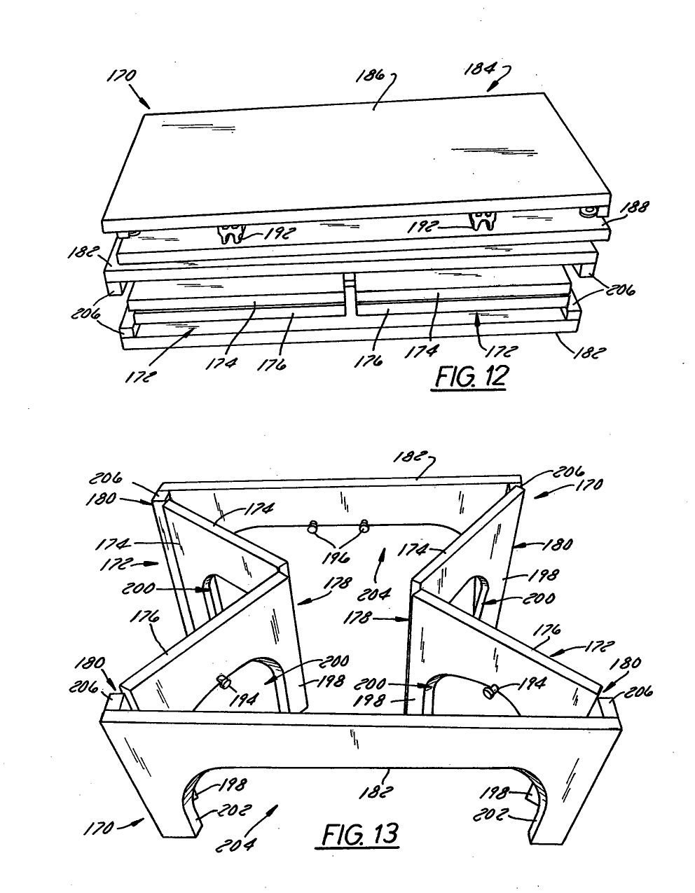

FIG. 12 illustrates another embodiment of a pet furniture assembly 170 that preferably is intended and configured for use by a cat, such as a common house cat. As shown in a disassembled condition, the pet furniture assembly 170 is compact for storage and shipping. This minimizes costs to the manufacturer, distributor and retailer.

The pet furniture assembly 170 includes a pair of collapsible/expandable wall sections 172 (22) defined by wall segments 174, 176 attached by a hinge 178 to each other and by a hinge 180 to each end wall 182 as best shown in FIG. 13. The assembly 170 includes a hinged panel assembly 184 made of a pair of panel halves 186, 188 connected by a hinge 190 enabling the halves to be unfolded into a generally planar or flat panel that can form a top wall of the assembly 170 when assembly is completed, such as is shown in FIG. 14, or can be configured to be a bottom wall (not shown), such as if the assembly is of reversible construction. Each panel half of the panel assembly 186, 188 has a plurality of clips 192 that each engage dowels 194 that extend inwardly from each one of the wall segments 174, 176 and dowels 196 that extend inwardly from each one of the end walls 182, such as is shown in FIG. 13.

As is also shown in FIGS. 12-14, sidewall segments 174, 176 each have legs 198 that define an archway-type opening 200 through which a cat can pass to go underneath panel assembly 184 when assembly is complete. The sidewalls can be connected to flanges 206 affixed to the right and left edges of the front and rear end walls 28 End walls 182 also have legs 202 between which a cat ingress/egress passage 204 is defined. A pad, such as a pad like mattress pad 58, can be laid over the top of the panel assembly 184 when the pet furniture assembly 170 is assembled, such as in the manner depicted in FIG. 14.

With reference generally to FIGS. 12-14, the end walls 182 define arches for a cat to pass through to enter the inside of a nook or nesting area underneath the panel assembly 184. The sidewalls 172 also have two entry points on either sidewall and the sidewalls 172 are able to fold inward about hinge 178 to allow the entire assembly 170 to collapse into a small storage space, for instance, under a person's bed or a couch. It may be important to a pet owner to be able to easily collapse the assembly 170 to hide it away at times. The sidewalls 172 are split into two sections 174, 176, as best shown in FIGS. 12 and 13. The sidewalls 172 can be connected to flanges 206 affixed to the right and left edges of the front and rear end walls 182. Knobs (not shown) may be affixed to sections of the pet bed walls in order to make collapsing or folding the pet bed easier during disassembly. Such knobs can also be used to facilitate assembly.

FIG. 14 shows the assembly 170 in a fully assembled condition. As shown, the side wall sections 174, 176 have a hinge 178 that is centrally vertically oriented, so as to allow each sidewall 172 to fold in half about hinge 178. The side wall sections 174, 176 are attachable to the end walls 182 by build-out flanges 206 connected to at least one of the front and rear edge of each sidewall 172 and left and right edges of each end wall 182 to provide an abutment surface between end walls 182 and sidewalls 172 when the box shaped frame is being formed as is depicted by the progression shown in FIGS. 13 and 14. A mattress support panel assembly 184 is supportable within the frame formed by the unfolded sidewall sections 174, 176 (shown in FIG. 14 in the unfolded condition) and end walls 182 beneath an upper edge of the frame so that the frame can retain a mattress, e.g., pad 208 shown in phantom in FIG. 14, against movement along the mattress support panel 184 when the mattress 208 is on either side of the mattress support panel.

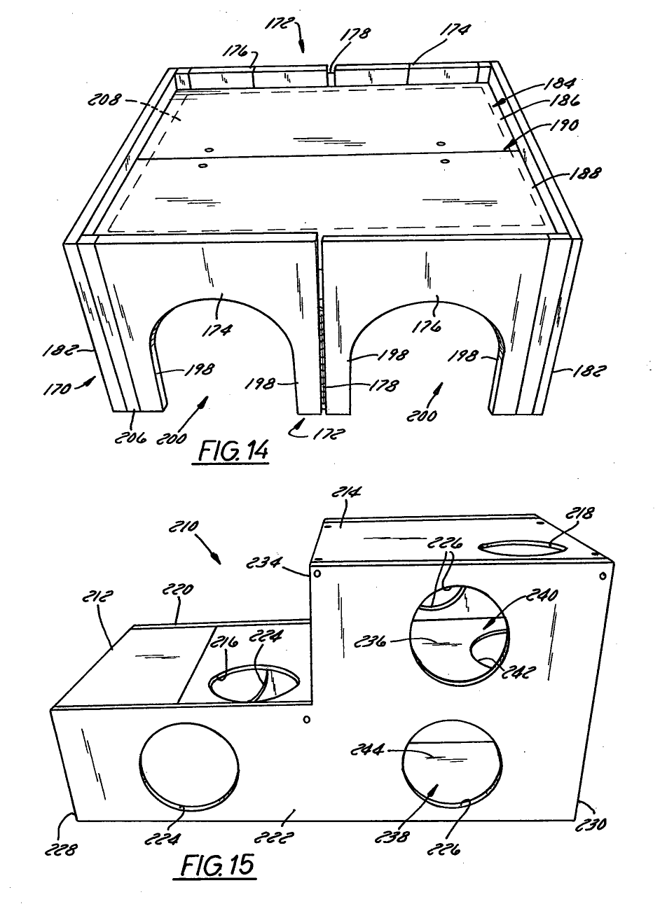

FIGS. 15 and 16 illustrate another preferred embodiment of an article of pet furniture 210 that is a maze for one or more cats. The article of pet furniture 210 has a plurality of top panels 212, 214 disposed at varying heights for enabling exploration by a cat. Each top panel 212, 214 has at least one opening 216, 218 sized large enough for a cat to pass through. There also is a pair of sidewalls 220, 222, only one of which is clearly shown, that each can have one opening and in the embodiment shown in FIGS. 15 and 16 have plurality of similarly sized cat openings 224, 226 formed therein. There also can be a pair of end walls 228, 230, with at least one of the end walls having at least one cat-sized opening 232 (FIG. 16) formed therein. In a preferred embodiment, each end wall 228, 230 has such a cat sized opening 232 formed therein. There also is a vertically extending upper section intermediate end wall 234 that can also have a cat-sized opening (not shown) formed therein.

Helping to form such a maze with the assembly 210 is a generally horizontal divider panel 236 disposed inside the assembly 210 that divides the article into a larger lower cat exploration chamber or maze segment 238 and a smaller upper cat exploration chamber or maze segment 240. The divider panel 236 also has at least one cat-sized opening 242 formed therein enabling a cat disposed inside the cat furniture article 210 to climb through the opening 242 from one chamber or segment 238 to the other chamber or segment 240 and vice versa. The cat furniture article 210 can also have a bottom 244 that can be formed of a panel or the like, which defines a floor for the bottom chamber 238, which can extend part of the length of the article 210 or substantially the entire length if desired. Such a maze-like, multi-chambered cat furniture assembly 210 provides multiple areas of exploration for a cat and takes advantage of their natural curious tendencies in facilitating play and exercise.

A pet furniture assembly 210 in accordance with the present invention can be constructed in a manner like that of assembly 30 shown in FIGS. 1-9 and described above or in a manner like that of assembly 170 shown in FIGS. 12-14 and described above. If desired, the components of maze 210 can also be assembled in another manner.

Various alternatives are contemplated as being within the scope of the following claims particularly pointing out and distinctly claiming the subject matter regarded as the invention. It is therefore also to be understood that, although the foregoing description and drawings describe and illustrate in detail one or more preferred embodiments of the present invention, to those skilled in the art to which the present invention relates the present disclosure will suggest many modifications and constructions as well as widely differing embodiments and applications without thereby departing from the spirit and scope of the invention.

It is claimed:

1. A pet furniture assembly comprised of a plurality of panels formable into a structure configured for animal interaction.

2. The pet furniture assembly of claim 1 wherein the plurality of panels comprise a plurality of walls with a generally horizontally disposed panel extending therebetween forming a support upon which a pet can rest.

3. The pet furniture assembly of claim 2 wherein the generally horizontally disposed panel and plurality of walls comprise a plurality of latching arrangements configured to attach the horizontally disposed panel to the plurality of walls.

4. The pet furniture assembly of claim 3 wherein each latching arrangement comprises a turn button attached to one of the horizontally disposed panel and one the walls that is receivable in a recess formed in the other one of the horizontally disposed panel and one of the walls.

5. The pet furniture assembly of claim 5 wherein each turn button is attached to the horizontally disposed panel and each recess comprises a rabbet or channel formed in a plurality of the walls.

6. The pet furniture assembly of claim 6 further comprising a finger disposed along each rabbet or channel that supports the horizontally disposed panel when a flange of each turn button is received in a corresponding one of the rabbets or channels.

7. The pet furniture assembly of claim 2 wherein the structure is movable between a first position where the horizontally disposed panel is disposed adjacent a surface upon which the structure rests forming an interior floor of the structure and a second position where the horizontally disposed panel is disposed distal from the surface upon which the structure rests forming a top wall of the structure.

8. The pet furniture assembly of claim 7 further comprising a layer comprised of a fabric disposed on the generally horizontally disposed panel when the structure is disposed in either one of the first and second position forming an interiorly disposed pet bed when the structure is oriented in the first position and an exteriorly disposed pet bed when the structure is oriented in the second position.

9. The pet furniture assembly of claim 1 wherein the plurality of panels comprises a pair of spaced apart end walls, a pair of spaced apart sidewalls, and an interconnecting panel extending between the end walls and sidewalls defining an open top structure in one position and an enclosed structure when disposed in another position.

10. The pet furniture assembly of claim 9 wherein the one position is opposite the another position.

11. The pet furniture assembly of claim 10 wherein the one position is 180 degrees from the another position.

12. The pet furniture assembly of claim 9 wherein one of the end walls and sidewalls has an opening formed in it that is large enough to allow passage of a pet therethrough.

13. The pet furniture assembly of claim 9 wherein the open top structure comprises an interiorly disposed pet bed and the enclosed structure comprises an exteriorly disposed pet bed.

14. The pet furniture assembly of claim 1 wherein one of the panels comprises a plurality of spaced apart fasteners and another one of the panels comprises a plurality of spaced apart fittings that releasably engage a corresponding one of the fasteners in forming the animal interaction structure.

15. The pet furniture assembly of claim 14 wherein each one of the fasteners comprises a post and each one of the fittings comprises an anchor that includes an elongate keyhole slot in which a corresponding one of the posts is releasably received.

16. The pet furniture assembly of claim 15 wherein each one of the posts has a shank extending outwardly from the one of the panels that has an enlarged head at its free end that is receivable in a enlarged portion of the keyhole slot and smaller than a width of a narrow portion of the keyhole slot.

17. The pet furniture assembly of claim 1 wherein the animal interaction structure comprises a box with an integrally formed bed with the box having an opening in one of the plurality of walls large enough for a pet to pass through and the box being of reversible construction positioning the bed on a bottom of the box when disposed in one position and the bed on a top of the box when disposed in another position.

18. The pet furniture assembly of claim 1 wherein the plurality of panels comprises a pair of opposed and spaced apart sidewalls and a pair of opposed and spaced apart end walls with each one of the pair of sidewalls and end walls comprising a flange that engages each one the other one of the pair of sidewalls and end walls.

19. The pet furniture assembly of claim 18 further comprising a fitting carried by each one of the of the pair of sidewalls and end walls and a fitting carried by each one the other one of the pair of sidewalls and end walls, and wherein engagement between each one of the fasteners and fittings provides releasable engagement therebetween.

20. The pet furniture assembly of claim 19 wherein each fastener comprises an outwardly extending fastener and each fitting comprises a keyhole fitting having a slot formed therein that releasably receives the fastener.

21. A pet furniture assembly comprising:
(a) a pair of spaced apart and opposed sidewalls;
(b) a pair of spaced apart and opposed end walls attached to each one of the sidewalls; and
(c) a panel in communication with at least one of the sidewalls and end walls that provides a floor when the pet furniture assembly is disposed in a first position where the sidewalls extend generally upwardly relative thereto and provides a roof when the pet furniture assembly is disposed in a second position where the sidewalls extend generally downwardly relative thereto.

22. The pet furniture assembly of claim 21 wherein one of the sidewalls and the end walls is configured to provide passage to an animal therethrough.

23. The pet furniture assembly of claim 21 further comprising a layer of fabric or padding carried by the panel on one surface of the panel when the pet furniture assembly is disposed in the first position and carried by the panel on the opposite surface of the panel when the pet furniture assembly is disposed in the second position.

24. The pet furniture assembly of claim 21 wherein each one of the pair of sidewalls and end walls comprises a first latching arrangement disposed in engagement with each one the other one of the pair of sidewalls and end walls and wherein the panel and one of the pair of sidewalls and end walls comprises a second latching arrangement securing the panel thereto.

25. The pet furniture assembly of claim 24 wherein each first latch arrangement comprises a fastener carried by one of the sidewalls and end walls that releasably engages a fitting carried by the other one of the sidewalls and end walls.

26. The pet furniture assembly of claim 25 further comprising a flange extending from each one of the sidewalls and end walls that carries at least one of the fasteners and fittings of at least one of the latching arrangements.

27. The pet furniture assembly of claim 25 wherein each fitting of each latching arrangement comprises a keyhole fitting.

28. The pet furniture assembly of claim 24 wherein the second latching arrangement comprises a movable coupler carried by one of the panel and one of the sidewalls and the end walls that is receivable in a socket carried by the other one of the panel and one of the sidewalls and end walls.

29. The pet furniture assembly of claim 28 wherein the movable coupler comprises a turn button having a rotatable outwardly extending finger and each one of the sockets comprises a recess in which the rotatable outwardly extending finger is receivable.

30. The pet furniture assembly of claim 28 further comprising a first support carried by one of the sidewalls and end walls that adjoins a portion of the panel providing support to the panel and a second support carried by the other one of the sidewalls and end walls that adjoins another portion of the panel providing support to the panel.

31. A pet furniture assembly comprising:
(a) a pair of spaced apart and opposed sidewalls;
(b) a pair of spaced apart and opposed end walls attached to each one of the sidewalls; and
(c) a panel carried by a plurality of sidewalls and end walls defining a lower pet supporting platform when the pet furniture assembly is disposed in one orientation and defining an upper pet supporting platform when the pet furniture assembly is disposed in an opposite orientation; and
wherein one of the sidewalls and end walls has a passage disposed therein to allow a pet to pass through.

32. The pet furniture assembly of claim 31 wherein the passage comprises an opening formed in the one of the sidewalls and end walls.

33. The pet furniture assembly of claim 31 further comprising a layer of fabric or padding carried by the panel on one surface of the panel when the pet furniture assembly is disposed in the one orientation and carried by the panel on the opposite surface of the panel when the pet furniture assembly is disposed in the opposite orientation.
